(19) United States
(12) Patent Application Publication
(10) Pub. No.: US 2012/0285776 A1
(43) Pub. Date: Nov. 15, 2012

(54) ELECTROMECHANICAL DISC BRAKE APPARATUS

(75) Inventor: Myoung June KIM, Seoul (KR)

(73) Assignee: MANDO CORPORATION

(21) Appl. No.: 13/467,745

(22) Filed: May 9, 2012

(30) Foreign Application Priority Data
May 9, 2011 (KR) 10-2011-0043264

(51) Int. Cl. B60T 1/06; F16D 65/18

(52) U.S. Cl. 188/72.1

(57) ABSTRACT

Disclosed is to an electromechanical disc brake apparatus in which a caliper housing has a reduced weight, enabling rapid braking.

### CROSS-REFERENCE TO RELATED APPLICATION

This application claims the benefit of Korean Patent Application No. 2011-0043264, filed on May 09, 2011 in the Korean Intellectual Property Office, the disclosure of which is incorporated herein by reference.

### BACKGROUND

1. Field

Embodiments of the present invention relate to an electromechanical disc brake apparatus in which a caliper housing has a reduced weight, enabling rapid braking.

2. Description of the Related Art

Generally, disc brake apparatuses are classified into a hydraulic disc brake apparatus using hydraulic pressure and an electromechanical disc brake apparatus using a motor.

A disc brake apparatus is mounted in a vehicle to slow or stop the vehicle during traveling, or to keep the vehicle stationary. The disc brake apparatus acquires brake force by strongly pressing both sides of a disc in the form of a circular plate using pads while the disc is rotated along with wheels.

Among the kinds of disc brake apparatuses, in particular, the electromechanical disc brake apparatus includes a pair of frictional pads to press both sides of a disc, a carrier to support the pair of frictional pads, a piston to press any one of the pair of frictional pads against the disc, a caliper housing having a cylinder in which the piston is accommodated, the caliper housing being reciprocally movably supported by the carrier via a guide rod, a motor to generate forward/reverse rotation force, a decelerator to amplify drive force generated from the motor, and a power conversion unit to convert rotation of the motor into rectilinear reciprocation of the piston.

Conventionally, the decelerator and motor are arranged at one side of the cylinder in a movement direction of the frictional pads. The power conversion unit generally includes a screw-shaft fastened to the piston.

That is, in the above-described electromechanical disc brake apparatus, drive force of the motor, which has been amplified by the decelerator, is transmitted to the screw-shaft. The piston, rotation of which is limited based on a rotating direction of the screw-shaft, rectilinearly reciprocates to press one frictional pad against the disc, and simultaneously the caliper housing slides to press the other frictional pad against the disc. In this way, as both the frictional pads come into contact with the disc, braking is conducted.

In the case of the hydraulic disc brake apparatus, a caliper housing includes a piston and a cylinder in which the piston reciprocates, and thus the weight of the caliper housing is not great. On the other hand, the caliper housing of the electromechanical disc brake apparatus includes additional components, such as, for example, the motor, decelerator, and power conversion unit, and therefore has a significantly increased weight. Accordingly, if the caliper housing moves relative to the carrier via the guide rod during braking, eccentric load is applied to the guide rod, which may prevent smooth braking.

Further, the motor, decelerator, and power conversion unit are generally mounted at the rear of the caliper housing, which may further increase eccentric load applied to the guide rod. This has a negative effect on sliding resistance of the carrier and caliper housing.

That is, the caliper housing of the electromechanical disc brake apparatus, which has a greater weight than the caliper housing of the hydraulic disc brake apparatus, has difficulty in conducting rapid braking.

### SUMMARY

Therefore, it is an aspect of the present invention to provide an electromechanical disc brake apparatus in which a motor and decelerator are mounted to a carrier other than a caliper housing, which may reduce the weight of the caliper housing.

Additional aspects of the invention will be set forth in part in the description which follows and, in part, will be obvious from the description, or may be learned by practice of the invention.

In accordance with one aspect of the present invention, an electromechanical disc brake apparatus, in which a pair of frictional pads presses a circular plate shaped disc that is rotated along with a vehicle wheel for braking, includes a carrier secured to a vehicle body, wherein a pair of frictional pads, which are configured to come into frictional contact with the disc, is reciprocally mounted to the carrier, a caliper housing having a guide rod to slidably couple the caliper housing to the carrier and a cylinder in which a piston to press any one of the pair of frictional pads against the disc is installed, a drive unit secured to the carrier, wherein the drive unit includes a motor and a decelerator to generate drive force, and a power conversion unit installed to the caliper housing to convert the drive force transmitted from the drive unit into rectilinear reciprocation of the piston.

The power conversion unit may include a screw-shaft having a predetermined length, the screw-shaft being provided at an outer peripheral surface of one end portion thereof with threads so as to be fastened to the piston.

The decelerator may include a first gear installed to a drive shaft of the motor, and a second gear engaged with the first gear, a center portion of the second gear being connected to the other end portion of the screw-shaft to transmit power generated from the drive shaft to the screw-shaft after reducing revolutions per minute of the drive shaft.

The first gear and the second gear may be kept in an engaged state even if axial displacement occurs.

Any one of the first and second gears may have a greater thickness.

The electromechanical disc brake apparatus may further include a fastening member to secure the drive unit to the carrier.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a plan view schematically illustrating an electromechanical disc brake apparatus according to an exemplary embodiment of the present invention;

FIG. 2 is a plan view schematically illustrating a braked state of the electromechanical disc brake apparatus according to the exemplary embodiment of the present invention; and

FIG. 3 is a reference view illustrating the side section of the electromechanical disc brake apparatus according to the exemplary embodiment of the present invention.

### DETAILED DESCRIPTION

Reference will now be made in detail to the embodiment of the present invention, examples of which are illustrated in the accompanying drawings, wherein like reference numerals refer to like elements throughout. The terms or words used in the specification and claims are not interpreted using typical or dictionary limited meanings, but are constructed as meanings and concepts conforming to the technical sprit of the embodiment based on the principle that the inventors can appropriately define the concepts of the terms to explain the embodiment in the best manner. Accordingly, it is to be understood that the detailed description, which will be disclosed along with the accompanying drawings, is intended to describe the exemplary embodiment and is not intended to represent all technical ideas of the embodiment. Therefore, it should be understood that various equivalents and modifications can exist which can replace the embodiments described in the time of the application.

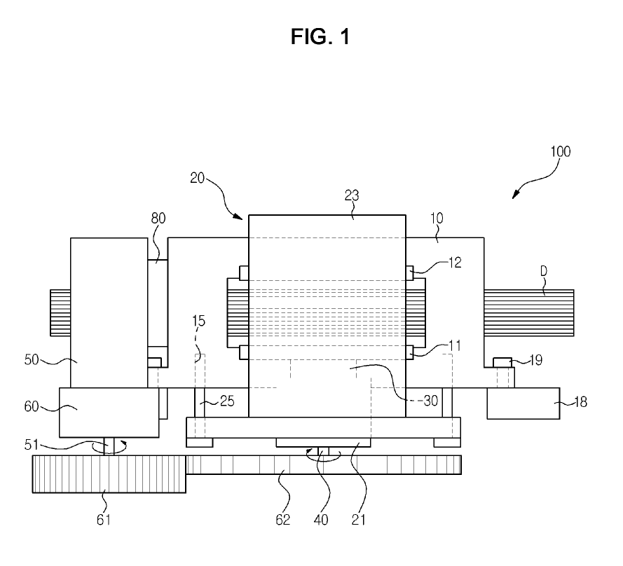

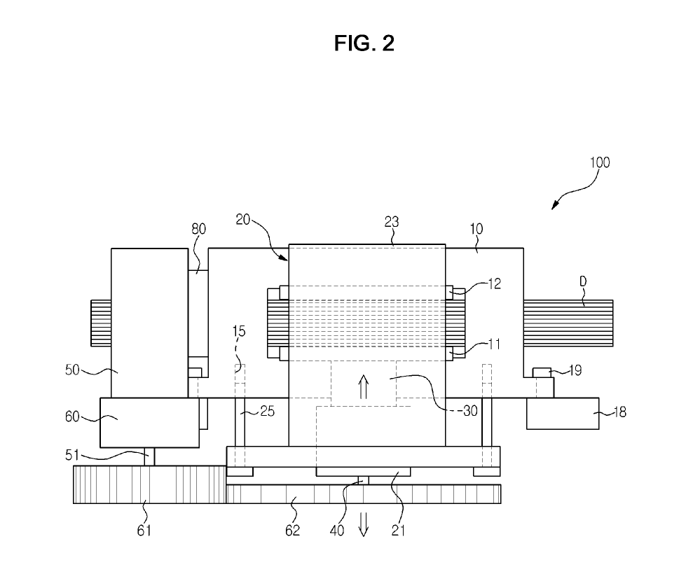

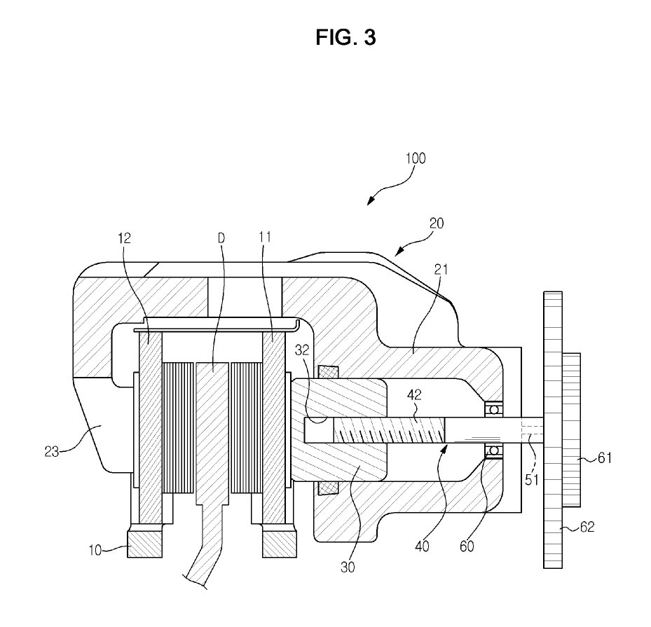

FIG. 1 is a plan view schematically illustrating an electromechanical disc brake apparatus according to an exemplary embodiment of the present invention, FIG. 2 is a plan view schematically illustrating a braked state of the electromechanical disc brake apparatus according to the exemplary embodiment of the present invention, and FIG. 3 is a reference view illustrating the side section of the electromechanical disc brake apparatus according to the exemplary embodiment of the present invention.

Referring to FIGS. 1 to 3, the electromechanical disc brake apparatus 100 includes a carrier 10 fixed to a vehicle body to support a pair of frictional pads 11 and 12, a caliper housing 20 movably coupled to the carrier 10, a drive unit installed to the carrier 10 to generate drive force, and a power conversion unit 40 to convert the drive force transmitted from the drive unit into rectilinear reciprocation.

The carrier 10 is firmly mounted to a knuckle 18 of the vehicle body via a mounting bolt 19. The pair of frictional pads 11 and 12 is adapted to come into frictional contact with a disc D, which is rotated along with a vehicle wheel (not shown), and is reciprocally mounted to the carrier 10. The pair of frictional pads 11 and 12 are spaced apart from each other with the disc D interposed therebetween. In this way, braking is conducted via rectilinear reciprocation of the frictional pads 11 and 12 with respect to the disc D.

Meanwhile, the carrier 10 has guide holes 15. The guide holes 15 are formed at positions corresponding to guide rods 25 mounted to the caliper housing 20 that will be described hereinafter for coupling of the guide rods 25. The guide holes 15 will hereinafter be described again.

The caliper housing 20 is provided with a cylinder 21, in which a piston 30 to press any one frictional pad 11 of the pair of frictional pads 11 and 12 against the disc D is accommodated. A finger 23 is integrally connected to the cylinder 21 so as to be bent downward at the front side of the caliper housing 20. The finger 23 may press the other frictional pad 12 against the disc D during sliding of the caliper housing 20. In this case, the pair of frictional pads 11 and 12 may be classified into the inner frictional pad 11 adjacent to the piston 30 and the outer frictional pad 12 located at an opposite side of the inner frictional pad 11.

A pair of guide rods 25 is formed respectively at both ends of the caliper housing 20 to slidably couple the caliper housing 20 to the carrier 10. As described above, a pair of guide holes 15 is formed at both the ends of the carrier 10 to correspond to the guide rods 25 respectively. Thus, as the guide rods 25 are respectively inserted into the guide holes 15, the caliper housing 20 is slidable from the carrier 10.

For braking, the piston 30 rectilinearly reciprocates upon receiving drive force of a motor 50 of the drive unit, thereby pressing the inner frictional pad 11 against the disc D. Here, the drive force of the motor 50 is first amplified via a decelerator 60, and then is transmitted to the piston 30 via the power conversion unit 40 that includes, e.g., a screw-shaft.

The piston 30 is accommodated in the cylinder 21 to reciprocate in a state in which rotation thereof is limited. The piston 30 is provided with threads 32 to be fastened to the power conversion unit 40. In this case, to limit rotation of the piston 30, an outer surface of the piston 30 and an inner surface of the cylinder 21, which correspond to each other for interconnection, may have a polygonal shape, or may be provided with a guide structure including a key and key recess (not shown).

The power conversion unit 40 includes the screw-shaft, which has a predetermined length and is provided at one end thereof with threads 42. The screw-shaft 40 is rotatably installed in the cylinder 21 to extend parallel to a reciprocating direction of the piston 30. The other end of the screw-shaft 40 penetrates the cylinder 21 in a backward movement direction of the piston 30 to extend outward from the cylinder 21. In this case, a bearing 70 is fitted to a through-hole of the cylinder 21 for penetration of the screw-shaft 40, to ensure smooth rotation of the screw-shaft 40.

The drive unit serves to transmit drive force, i.e. rotating force to the screw-shaft 40, and includes the motor 50 and the decelerator 60.

The motor 50 is located at the outside of the carrier 10 to rotate the decelerator 60 forward or in reverse.

The decelerator 60 includes a first gear 61 connected to a shaft 51 of the motor 50, and a second gear 62 engaged with the first gear 61, the second gear 62 being connected to the screw-shaft 40. Although not shown, alternatively, the decelerator 60 may include a sun gear connected to the shaft 51 of the motor 50, planetary gears arranged around the sun gear so as to be engaged with the sun gear, and a carrier to connect shafts of the planetary gears and the screw-shaft. However, in the present embodiment, the decelerator 60 is described as having a simplified configuration consisting of the first gear 61 and the second gear 62 to rotate the screw-shaft 40.

Accordingly, as the shaft 51 is rotated via operation of the motor 50, the first gear 61 and the second gear 62 are rotated together to transmit drive force to the screw-shaft 40, decelerating rotation of the screw-shaft 40. Thereby, as the motor 50 is rotated forward or in reverse, the screw-shaft 40 is rotated forward or in reverse, causing rectilinear reciprocation of the piston 30.

Meanwhile, according to the embodiment of the present invention, as the caliper housing 20 moves relative to the piston 30 during braking, axial displacement occurs. In this case, the first gear 61 and the second gear 62 are kept in an engaged state even if the axial displacement occurs.

For example, to keep the gears 61 and 62 in an engaged state, it is proposed to provide one of the first and second gears 61 and 62 with a greater thickness. That is, as shown, the thickness of the first gear 61 is greater than the thickness of the second gear 62. In this case, a difference between the thicknesses of the first gear 61 and the second gear 62 may be a length corresponding to the axial displacement, i.e. an axial movement distance. To this end, the difference between the thicknesses of the first gear 61 and the second gear 62 may be equal to or greater than the magnitude of the axial displacement. Also, the thickness of the first gear 61 may be increased or decreased based on the magnitude of the axial displacement.

According to the embodiment of the present invention, the electromechanical disc brake apparatus 100 further includes a fastening member 80 to secure the drive unit to the carrier 10.

The fastening member 80 serves to stably secure the motor 50 and/or the decelerator 60 to the carrier 10. For example, the fastening member 80 may take the form of a frame-shaped case secured to the carrier 10, in which the motor 50 and the decelerator 60 are installed, or may be a bracket to directly secure the motor 50 to the carrier 10 using a bolt, etc., or may be an adhesive pad containing an adhesive. It will be understood that the fastening member 80 may employ any one configuration so long as it secures the motor 50 and the decelerator 60 to the carrier 10.

A braking operation by the electromagnetic disc brake apparatus 100 having the above-described configuration will hereinafter be described.

First, the motor 50 and the decelerator 60 are secured to the carrier 10 of the vehicle body using the fastening member 80, and the caliper housing 20 is slidably coupled to the carrier 10. In this case, upon braking, the piston 30 is moved to the disc D by the screw-shaft 40 that is rotated upon receiving drive force from the motor 50, thereby pressing the inner frictional pad 11 against the disc D. The caliper housing 20 is moved in an opposite direction of a movement direction of the piston 30 by repulsive force between the piston 30 and the outer frictional pad 12. Thereby, the finger 23 provided at the front side of the caliper housing 20 presses the outer frictional pad 12 against the disc D, enabling braking using friction between the pair of frictional pads 11 and 12 and the disc D.

In this way, securing the drive unit to the carrier 10 results in a considerable reduction in the weight of the caliper housing 20 as compared to the related art, ensuring easier sliding of the caliper housing 20. That is, eccentric load applied to the guide rod 25 that connects the caliper housing 20 to the carrier 10 is reduced, resulting in smooth braking.

Also, providing the first gear 61 and the second gear 62 that transmit drive force of the motor 50 to the screw-shaft 40 with different thicknesses allows the gears 61 and 62 to be kept in an engaged state rather than being spaced apart from each other even if axial displacement of the caliper housing 20 occurs, which ensures stable braking.

As is apparent from the above description, an electromechanical disc brake apparatus according to the embodiment of the present invention is configured such that a motor and a decelerator are mounted to a carrier other than a caliper housing, which may reduce the weight of the caliper housing as compared to the related art, and consequently reduce eccentric load applied to a guide rod connected to the carrier. This ensures rapid movement of the caliper housing relative to the carrier during braking. That is, smooth braking is accomplished.

Further, removing eccentric load applied to the guide rod may prevent wear and noise due to friction between the guide rod and a guide hole, which may reduce costs for the repair and replacement of elements.

Furthermore, as a result of providing gears used to transmit drive force to a screw-shaft with different thicknesses, the gears may be kept in an engaged state even if axial displacement occurs during braking, which may ensure stable braking. This may enhance product reliability.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An electromechanical disc brake apparatus in which a pair of frictional pads presses a circular plate shaped disc that is rotated along with a vehicle wheel for braking, the apparatus comprising:
a carrier secured to a vehicle body, wherein a pair of frictional pads, which are configured to come into frictional contact with the disc, is reciprocally mounted to the carrier;
a caliper housing having a guide rod to slidably couple the caliper housing to the carrier and a cylinder in which a piston to press any one of the pair of frictional pads against the disc is installed;
a drive unit secured to the carrier, wherein the drive unit includes a motor and a decelerator to generate drive force; and
a power conversion unit installed to the caliper housing to convert the drive force transmitted from the drive unit into rectilinear reciprocation of the piston.

2. The apparatus according to claim 1, wherein the power conversion unit includes a screw-shaft having a predetermined length, the screw-shaft being provided at an outer peripheral surface of one end portion thereof with threads so as to be fastened to the piston.

3. The apparatus according to claim 2, wherein the decelerator includes:
a first gear installed to a drive shaft of the motor; and
a second gear engaged with the first gear, a center portion of the second gear being connected to the other end portion of the screw-shaft to transmit power generated from the drive shaft to the screw-shaft after reducing revolutions per minute of the drive shaft.

4. The apparatus according to claim 3, wherein the first gear and the second gear are kept in an engaged state even if axial displacement occurs.

5. The apparatus according to claim 4, wherein any one of the first and second gears has a greater thickness.

6. The apparatus according to any one of claims 1 to 5, further comprising a fastening member to secure the drive unit to the carrier.
